(19) United States
(12) Patent Application Publication
(10) Pub. No.: US 2005/0237065 A1
(43) Pub. Date: Oct. 27, 2005

(54) Compartment-arrayed probe for measuring extracellular electrical potential and method of measuring pharmacological effect using the same

(76) Inventors: Suguru Kudoh, Ikeda-shi (JP); Takahisa Taguchi, Ikeda-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/059,826

(22) Filed: Feb. 16, 2005

(30) Foreign Application Priority Data
Feb. 17, 2004 (JP) 2004-39490

(51) Int. Cl. G01N 27/02

(52) U.S. Cl. 324/447

(57) ABSTRACT

The present invention provides a compartment-arrayed probe for measuring extracellular electrical potential, the probe comprising: a compartment body (1) having a plurality of through-holes; and an electrode substrate (2) composed of a non-electrically conductive material, on one surface of which the plurality of measurement electrodes are disposed and a tubular member (3) is disposed in such a manner as to surround the measurement electrodes; wherein one surface of the compartment body (1) to which each of the through-holes opens is adhered to an area surrounded by the tubular member (3) on the electrode substrate (2) in such a manner that at least a part of the plurality of through-holes surround a part of the plurality of measurement electrodes; a part of an inner wall surface of the through-hole contacts a culture medium when it is injected thereinto; the part of the inner wall surface is composed of an electrically conductive material; and the electrical potential of the measurement electrode is measured with reference to the part of the inner wall surface of the through-hole contacting the culture medium as a reference electrode.

### BACKGROUND OF THE INVENTION

(1) Field of the Invention

The present invention relates to an extracellular electrical potential measurement probe enabling a multi-point simultaneous measurement of extracellular electrical potential and a method for measuring a pharmacological effect using the same.

(2) Description of the Related Art

Currently known are a means for measuring electrical potential, which reflects the activity of a nerve cell and is generated on the cell surface, at a plurality of points on the cell surface, and a means for applying electrical stimulation to the cell surface at a plurality of points on the cell surface. For example, Japanese Unexamined Patent Publication No. 1996-62209 (hereinafter referred to as Patent Document 1) discloses a means for measuring extracellular electrical potential or applying electrical stimulation to a cell using an extracellular-electrical potential measuring electrode assembly having a plurality of microelectrodes arranged on an insulating substrate and a wall enclosing the region including the microelectrodes while cultured cells in the region enclosed by the wall.

Japanese Unexamined Patent Publication No. 1999-187865 (hereinafter referred to as Patent Document 2) overcomes the drawbacks of the cell electrical potential measuring electrode disclosed in Patent Document 1. More specifically, according to the electrode of Patent Document 1, when using one microelectrode as a reference electrode for measuring electrical potential (hereinafter referred to as “reference electrode”), the noise level varies significantly depending on the microelectrode selected as a reference electrode, while when using a plurality of microelectrodes as the reference electrode, it requires skill to place a cell on the cell electrical potential measuring electrode while not contacting the reference electrodes. In order to solve these problems, Patent Document 2 discloses a cell electrical potential measuring electrode in which a plurality of reference electrodes with a larger area than that of the microelectrode are provided at a predetermined distance from the region of a plurality of microelectrodes.

As disclosed in Patent Documents 1 and 2, a probe for measuring extracellular electrical potential at a plurality of points is known. Such a probe enables a multi-point simultaneous measurement of electrical potential with respect to one sample, however it cannot conduct a simultaneous measurement of electrical potential with respect to a large number of samples and cannot simultaneously perform a large number of measurements under various culture conditions. Such measurements are especially essential when assaying a sample for a pharmacological effect. In order to analyze the pharmacological effect under various conditions, a probe is required that can simultaneously analyze the effects of a pharmaceutical agent on the electrical activities of each cell colony, which has been cultivated as homogenously as possible.

Further, the selection of the type of reference electrode, i.e., the shape and the arrangement of the reference electrode, is important. In particular, it is difficult to form a suitable reference electrode in a probe provided with a plurality of small and independent regions. For example, when a reference electrode is provided on a substrate for each small and independent region in the same manner as the measurement electrode, the following problems may occur: the area of the reference electrodes cannot be made sufficiently large, the impedance may be high, the reference electrode may be susceptible to noise, and oscillation may occur in the signal amplifier of the measurement device. It may also be difficult to prevent the sample from simultaneously contacting the reference electrode and the measurement electrode in order to carry out an accurate measurement. Also, the method of forming a plurality of reference electrodes at a position distant from the region of the measurement electrodes as disclosed in Patent Document 2 does not allow the formation of a reference electrode at each small and independent region. As shown in FIG. 8, when a needle-like reference electrode 30 is inserted into each small region from the outside of the substrate on which the measurement electrode is provided, the handling becomes troublesome and the injection of a drug medium into each small region becomes difficult.

### BRIEF SUMMARY OF THE INVENTION

An object of the present invention is to solve the above-described problems of the prior art. More specifically, an object of the present invention is to provide an extracellular electrical potential measurement probe which enables simultaneous measurement under various culture conditions, in which the impedance of the reference electrode is low, the reference electrode is not easily affected by noise, and oscillation is not induced and to also provide a method for measuring a pharmacological effect using the same.

The object can be achieved by the following methods:

More specifically, the present invention provides a compartment-arrayed probe for measuring extracellular electrical potential which has a plurality of measurement electrodes, the probe comprising: a compartment body having a plurality of through-holes; and an electrode substrate composed of a non-electrically conductive material, on one surface of which the plurality of measurement electrodes are disposed and a tubular member is disposed in such a manner as to surround the measurement electrodes; wherein one surface of the compartment body to which each of the through-holes opens is adhered to an area surrounded by the tubular member on the electrode substrate in such a manner that at least a part of the plurality of through-holes surround a part of the plurality of measurement electrodes; an inner wall surface of the through-hole contacting a culture medium when it is injected thereinto, the inner wall surface being composed of an electrically conductive material; and the electrical potential of the measurement electrode is measured with reference to the part of the inner wall surface of the through-hole contacting the culture medium as a reference electrode.

In the compartment-arrayed probe for measuring extracellular electrical potential of the invention, the entire compartment body may be composed of an electrically conductive material.

In the compartment-arrayed probe for measuring extracellular electrical potential according of the invention, the compartment body may be composed of a non-electrically conductive material; and the compartment body has a surface which may be plated, or to which an electrically conductive coating may be applied or sprayed.

In the compartment-arrayed probe for measuring extracellular electrical potential of the invention, the inner surface of the through-hole may be composed of silver-silver chloride.

In the compartment-arrayed probe for measuring extracellular electrical potential of the invention, the openings of the plurality of through-holes may be equal in shape and area.

In the compartment-arrayed probe for measuring extracellular electrical potential of the invention, the openings of the plurality of through-holes may be equal in shape; and among the plurality of through-holes, the area of some through-holes may vary in an approximate geometric progression relative to a predetermined through-hole opening area.

The invention provides First method for measuring a pharmacological effect using a compartment-arrayed probe for measuring extracellular electrical potential comprising: a compartment body having a plurality of through-holes whose inner wall is at least partially composed of an electrically conductive material; and an electrode substrate composed of a non-electrically conductive material, on one surface of which the plurality of measurement electrodes are disposed and a tubular member is disposed in such a manner as to surround the measurement electrodes, wherein one surface of the compartment body to which the through-holes open is adhered to an area surrounded by the tubular member on the electrode substrate in such a manner that at least a part of the plurality of through-holes surround a part of the plurality of measurement electrodes, the method comprising: a first step of injecting a culture medium inside the tubular member of the compartment-arrayed probe for measuring extracellular electrical potential in such a manner as to submerge the compartment body so as to culture a nerve cell; a second step of replacing the culture medium in the through-hole with an extracellular electrical potential recording medium while injecting the recording medium in such a manner as to contact part of the inner wall surface; a third step of measuring the electrical potential of the measurement electrode after a predetermined interval of time with reference to the part of the inner wall surface of the through-hole contacting the culture medium as a reference electrode; a fourth step of injecting a reagent to be assayed into each of the through-holes; and a fifth step of measuring the electrical potential of the measurement electrode after a predetermined interval of time with reference to the part of the inner wall surface of the through-hole contacting the culture medium as a reference electrode.

The present invention provides Second method for measuring a pharmacological effect comprising: a first step of culturing a nerve cell on a predetermined area surrounded by a tubular member on an electrode substrate composed of anon-electrically conductive material, on one surface of which a plurality of measurement electrodes are disposed and the tubular member is disposed in such a manner as to surround the measurement electrodes; a second step of adhering one surface of a compartment body, to which a plurality of through-holes open, to the predetermined area in such a manner that at least a part of the plurality of through-holes surround a part of the plurality of measurement electrodes, wherein inner walls of the through-holes are at least partially composed of an electrically conductive material; a third step of replacing the culture medium in each through-hole with an extracellular electrical potential recording medium while injecting the medium in such a manner as to contact part of the inner wall surface; a fourth step of measuring the electrical potential of the measurement electrodes after a predetermined interval of time with reference to the part of the inner wall surface of the through-hole contacting the culture medium as a reference electrode; a fifth step of injecting a reagent to be assayed into each of the through-holes; and a sixth step of measuring the electrical potential of the measurement electrodes after a predetermined interval of time with reference to the part of the inner wall surface of the through-hole contacting the culture medium as a reference electrode.

In First and Second methods for measuring a pharmacological effect according to the invention, the openings of the plurality of through-holes may be equal in shape and area.

In First and Second methods for measuring a pharmacological effect according to the invention, the openings of the plurality of through-holes may be equal in shape; and among the plurality of through-holes, the area of each of some through-holes may vary in an approximate geometric progression relative to a predetermined through-hole opening area.

With respect to the compartment-arrayed probe for measuring extracellular electrical potential, simultaneous measurement under various culture conditions can be conducted, the impedance of the reference electrode is low, the measurements are not easily affected by noise, and oscillation is not likely to occur in the measurement device.

A plurality of measurement electrodes are densely arranged on one electrode substrate, and the measurement electrodes are divided into two or more separate compartments by a compartment body, thereby enabling simultaneous observation of a large number of measurement targets on one probe. Further, simultaneous observation of a large number of targets under various pharmacological conditions can be conducted, thereby enabling an efficient assay of pharmacological effects on the targets.

The size of the compartments divided by the compartment body is small, and they are arranged in proximity to each other. Such a configuration is not likely to cause any deviation in measurement results due to differences in the conditions for development of cells, etc., and is suitable for simultaneous observation of cultured cells.

Since the compartment body is provided separately from the electrode substrate, the compartment body can be exchanged according to the object of the experiment, i.e., to culture cells and measure the extracellular electrical potential. For example, by varying the area of each compartment of the compartment body, differences in pharmacological reaction among cultured cells depending on the culture area can be verified.

Since the reference electrode has a large area and low impedance, it provides excellent noise characteristics during extracellular electrical potential measurement, and excellent electrical stimulation characteristics when electrically stimulating cells.

Since a cell does not simultaneously contact the measurement electrode and the reference electrode (more specifically, the culture medium-immersed part of the inner wall surface of each compartment of the compartment body) as it does when the reference electrode and the measurement electrodes are disposed on an electrode substrate surface in the same compartment, normal measurement can be conducted.

Further, the present invention prevents another cell other than a cell on measurement electrodes from contacting the reference electrode while overlapping on the cell on the measurement electrode as it does when the reference electrode and the measurement electrodes are disposed on the surface of the electrode substrate in the same compartment, thereby allowing normal measurement.

Since the space for the reference electrode on the electrode substrate can be reduced, the area of each division can be made small, thereby miniaturizing the entire size of the probe.

### BRIEF DESCRIPTION OF SEVERAL VIEWS OF THE DRAWINGS

FIG. 1 is a perspective view schematically showing the structure of a compartment-arrayed extracellular electrical potential measurement probe according to one embodiment of the invention.

FIG. 2 is a view showing a compartment body of a compartment-arrayed extracellular electrical potential measurement probe according to one embodiment of the invention. FIG. 2(a) is a plan view thereof and 2 (b) is a front elevation view thereof.

FIG. 3 is a plan view showing an electrode substrate of a compartment-arrayed extracellular electrical potential measurement probe according to one embodiment of the invention.

FIG. 4 is a plan view showing a compartment body of a compartment-arrayed extracellular electrical potential measurement probe according to another embodiment of the invention.

FIG. 5 is a perspective view showing one embodiment of the invention.

FIG. 6 is a signal waveform observed when a reference electrode is disposed on the surface of the bottom of an extracellular electrical potential measurement substrate.

FIG. 7 is a signal waveform observed when the compartment-arrayed extracellular electrical potential measurement probe of the invention is used.

FIG. 8 is a perspective view showing a prior-art probe employing a plurality of needle-like reference electrodes.

### DETAILED DESCRIPTION OF THE INVENTION

Hereinafter, the present invention is described according to one embodiment with reference to drawings. FIG. 1 is a perspective view showing the structure of a compartment-arrayed extracellular electrical potential measurement probe according to one embodiment of the invention. The compartment-arrayed extracellular electrical potential measurement probe is provided with a compartment body 1 which is composed of an electrically conductive material, and an electrode substrate 2 which is composed of a non-electrically conductive material and which is provided with a cylindrical member 3. The probe is used for electrical potential measurement when the compartment body 1 is attached to the surface of the electrode substrate 2 inside the cylindrical member 3 by a predetermined procedure.

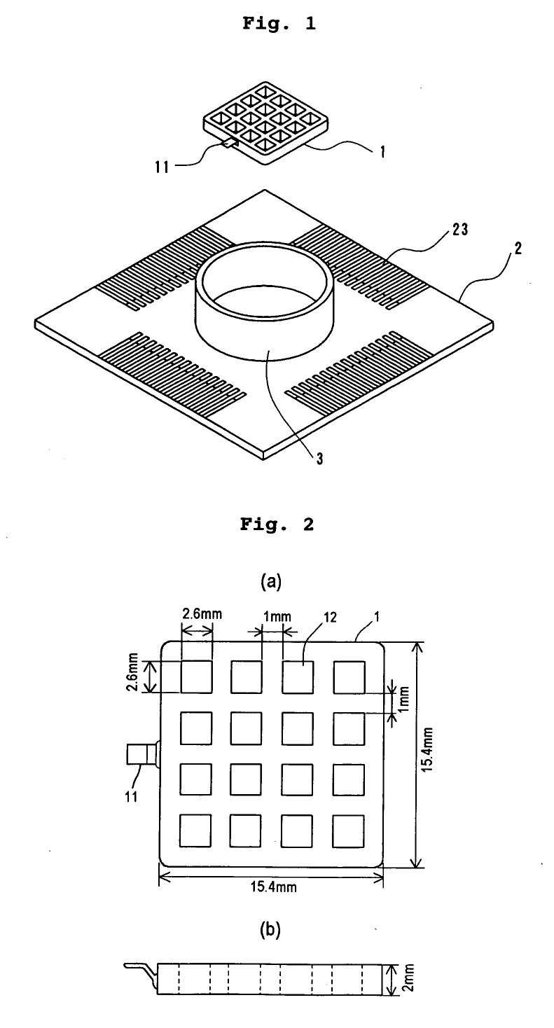

FIG. 2 shows the compartment body 1 of FIG. 1, and FIG. 2 (a) is a plan view thereof and 2(b) is a front elevation view thereof. As shown in FIG. 2, the compartment body 1 has a substantially rectangular external form and is provided with a plurality of through holes 12. The openings of through holes 12 are the same in shape, i.e., square, and area. One side wall of the compartment body 1 is equipped with a lead member 11 to be connected to wiring. For example, the compartment body 1 has a lattice form that is a square about 15.4 mm on a side, with a height of about 2 mm and a thickness of about 1 mm, and is provided with 16 through holes 12, each of which has a square aperture about 2.6 mm on a side (4 through holes are arranged in each row and column, respectively).

The compartment body 1 is composed of an electrically conductive material, such as a metal. Since a culture medium is held by the compartment body 1, which is described later, the compartment body 1 is preferably made of a metal, such as titanium, stainless steel, a nickel alloy, etc., which is passivated due to an oxide film that is formed on the surface in the air, or a noble metal, such as gold, platinum, silver, etc., which is highly corrosion-resistant.

The lead member 11 is made of an electrically conductive material, and is electrically connected to the compartment body 1. The lead member 11 is desirably composed of a corrosion-resistant material as is the compartment body 1, if it is to be immersed in a culture medium.

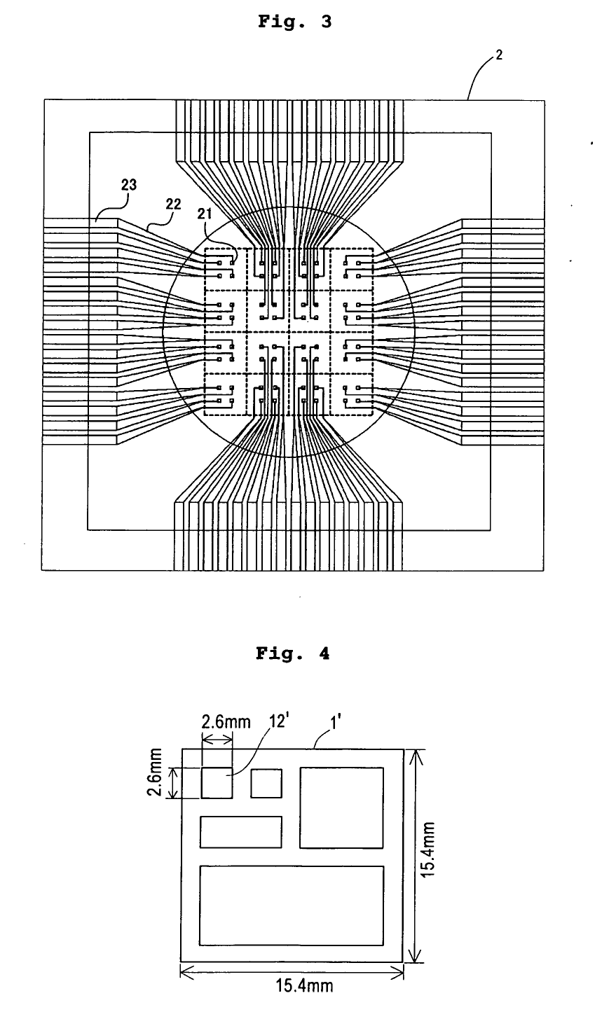

FIG. 3 is a plan view illustrating the electrode substrate 2 shown in FIG. 1. In FIG. 3, the position of the cylindrical member 3 is shown by the circle, and the attachment position of the compartment body 1 is shown by the dashed line. The electrode substrate 2 is a square about 50 mm on a side and is about 1 mm thick. The electrode substrate 2 and the cylindrical member 3 are composed of a non-electrically conductive material, such as glass or plastic. Two or more measurement electrodes 21 of an electrically conductive material are disposed near the center of the surface of the electrode substrate 2 at predetermined intervals between each other. In the neighborhood of each side of the electrode substrate 2, a plurality of contact terminals 23 are provided at predetermined intervals between each other. The corresponding measurement electrode 21 and contact terminal 23 are connected to each other via an electrically conductive wiring pattern 22.

The measurement electrode 21 is made of, for example, platinum, and four pieces thereof are provided at each compartment of the compartment body 1 and are arranged at intervals of about 1 mm between each other in each compartment. The measurement electrode 21, the wiring pattern 22, and the contact terminal 23 are formed on the electrode substrate by etching in the same manner as disclosed in Patent Documents 1 and 2.

The compartment body 1 is attached to the surface of the electrode substrate 2 inside the cylindrical member 3 by applying a predetermined amount of silicone grease to the bottom surface of the compartment body 1, and then pressing the body 1 to the surface of the electrode substrate 2. The amount of silicone grease should be as small as possible, while being sufficient to tightly adhere the bottom of the compartment body 1 to the surface of the electrode substrate 2.

Cell culture using the compartment-arrayed extracellular electrical potential measurement probe of this embodiment is carried out as follows: a culture medium is injected into the cylindrical member 3 while the compartment body 1 is not attached to the electrode substrate 2, and cells are cultivated therein. Subsequently, the compartment body 1 with the bottom coated with silicone grease is pressed onto the electrode substrate 2 immediately before a pharmacological assay, thereby forming two or more separate compartments (hereinafter referred to as the “compartment pressing method”). Alternatively, cell culture may be conducted as follows: the compartment body 1 can be tightly pressed onto the electrode substrate 2 using adhesive in advance to form independent compartments. Subsequently, a culture medium is injected into every independent compartment formed and cells are cultivated therein (hereafter referred to as the “compartment culture method”). It is preferable to use an adhesive with a comparatively high bio-compatibility, such as a cyanoacrylate-based adhesive, epoxy-based adhesive, etc., and to sufficiently dry the adhesive employed after adhesion. Either the compartment pressing method or the compartment culture method can be selected according to the target and item to be measured. In order to avoid cell death during culture, the compartment culture method requires the use of a compartment body 1 whose height is determined according to the oxygen demand of the cell so that oxygen can be supplied sufficiently to the deep part of the compartment body 1 (near the surface of the electrode substrate).

When the compartment-arrayed extracellular electrical potential measurement probe of this embodiment is used for extracellular electrical potential measurement, the wiring connected to the lead member 11 is connected to the reference electrode terminal of a measurement device. This allows the compartment body 1 to serve as a reference electrode for each corresponding measurement electrode. More specifically, the electrical potential of each measurement electrode is determined with reference to the electrical potential of the compartment body 1. Under this state, the electrical potential of each measurement electrode is input into an amplifier as an analog signal via the corresponding contact terminal 23, and passes through an A/D converter to be obtained as digital data by a measurement device provided with a computer (neither is illustrated). Since the procedure is well known to persons skilled in the art by the disclosures of Patent Documents 1, 2, etc., a detailed explanation thereof is omitted here.

As described above, the compartment-arrayed extracellular electrical potential measurement probe of this embodiment uses the entire compartment body 1 as a reference electrode, thereby sufficiently enlarging the area of the reference electrode in contact with the culture medium and lowering the impedance. Therefore, the influence of noise and the oscillation of the measurement device can be suppressed.

In the above, an embodiment in which the compartment body 1 is entirely made of an electrically conductive material is described, but other embodiments can be employed without limitation. For example, the compartment body 1 can be made of a non-electrically conductive material, such as plastic, and a metal film formed on the surface by a metal-plating treatment. Alternatively, instead of the metal-plating treatment, an electrically conductive coating agent may be applied or sprayed onto the surface, to form an electrically conductive film on the surface. The entire surface of the compartment body 1 does not need to have electrical conductivity. At a minimum, the inner wall part of the compartment body 1 contacting the injected culture medium should be electrically conductive to allow electrical connection to the lead part 11.

With respect to using the probe, it is desirable to form the surface of the compartment body 1 with silver-silver chloride for avoiding polarization. For example, the compartment body 1 can be composed of silver, and silver-silver chloride can be formed on the surface thereof in hydrochloric acid.

The external shape of the compartment body 1 is not limited to the above-described substantially rectangular shape, and may be, for example, a cylindrical or polygonal column.

The shape of the opening of the through hole 12 of the compartment body 1 is not limited to the above-described square shape, and may take any shape without limitation, such as a rectangular shape, round shape, etc. The area of the opening of each through hole 12 does not necessarily need to be equal. For example, the area of each opening may increase in an approximate geometric progression with reference to a predetermined opening area. One example is shown in FIG. 4. FIG. 4 is a plan view showing a compartment body 1′ provided with through holes in such a manner as that the area of each opening increases about twice, about 4 times, and about 8 times based on the minimum area of opening 12′. Thus, the use of a compartment body having through holes with different sizes can facilitate, for example, an experiment for verifying the difference in the pharmacological reaction of cultured cells depending on the culture area.

The attachment position of the lead member 11 to the compartment body 1 is not limited to the above-described outside wall of the compartment body 1 as long as the impedance of the connection part of the lead member 11 and the compartment body 1 is sufficiently low. For example, the lead member 11 may be attached to, for example, the center of the upper surface to which the through holes 12 of the compartment body 1 open.

The means of attaching the compartment body 1 to the surface of the electrode substrate 2 in the compartment pressing method is not limited to silicone grease, and a high bio-compatible material with water repellence and tackiness may be employed.

The size, arrangement, and number of the measurement electrode 21, circuit pattern 22, and contact terminal 23 on the electrode substrate 2 are not limited to the above, and may be modified.

The wall to be attached to the electrode substrate 2 for holding the culture medium is not limited to the above-described cylindrical member 3, and may take any form as long as the form and the size are suitable for accommodating the entire compartment body 1.

Hereinafter, the pharmacological effect measurement method using the compartment-arrayed extracellular electrical potential measurement probe is explained. In the case of the above-described compartment pressing method, the pharmacological effect can be measured in the following steps.

First step: Firstly, a neuronal network is cultured in a region surrounded by the cylindrical member 3 on the electrode substrate 2 as shown in FIG. 1 (hereinafter referred to as a culture domain). A case in which the nerve cells of rats are used is given as an example. The brain is isolated from the rats on embryonic day 18 and the hippocampus is excised. A slice of the hippocampus is placed in a 15-ml centrifuge tube with a transfer pipette together with a Working Solution (a solution in which PBS-+10 mM Glucose and D-MEM base (W/O sodium hydrogencarbonate) have a ratio of 1:1, and which is cooled to 0° C.). Decantation is carried out twice in a PBS-solution heated to 37° C. A 2% trypsin-EDTA solution and a PBS-solution are then added thereto, making a total volume of 2 ml. The final trypsin concentration is 0.2%. A trypsin treatment is conducted at 37° C. for 10 minutes, and the PBS-solution is removed. A culture medium containing a blood serum is then added, decantation is carried out three times, thus completing an enzyme reaction. Subsequently, pipetting is conducted about 10 times using a transfer pipette, to dissociate nerve cells. After the number of dissociated nerve cells is counted using a hemocytometer, the nerve cells are diluted into a suitable concentration and the diluted nerve cells are then seeded onto the culture domain, which is warmed by placing the culture medium into a CO₂ incubator beforehand. After this, a neuronal network is formed by culture.

Second step: In order to perform a pharmacological assay, the compartment body 1 is pressed onto the culture domain inside the cylindrical member 3, thereby dividing the neuronal network that was formed by culture in the 1st step into parts.

Third step: The culture medium in each compartment formed by the through holes 12 is replaced by an electrolyte solution to record the extracellular electrical potential (hereinafter referred to as an extracellular electrical potential recording solution). For example, using a pipette tip with a tip diameter size that allows it to enter each compartment, the culture medium of each compartment is removed and replaced with an extracellular electrical potential recoding solution of the following composition: 120 NaCl, 3 KCl, 2.5 CaCl₂, 1 MgCl₂, 10 glucose and 10 Na-Hepes (pH 7.3, in mM), wherein the osmolarity is adjusted to 300 mOsm using sucrose. The extracellular electrical potential recording solution is not limited to the above composition insofar as the solution is an electrolyte solution which allows the cells to survive, and which contains a nutrient for cell activity.

Fourth step: After a pause to enable the activity of the nerve cells to sufficiently stabilize, the electrical potential changes of the measurement electrode 21 (see FIG. 3) are measured and recorded for a predetermined time with reference to the inner wall of the compartment body 1, which serves as a reference electrode. This allows the measurement and recording of stable neuroelectrical activity as the action potential change in the vicinity of the measurement electrode 21. In the culture scale of the 1st step given as an example, a sufficient pause is usually about 10 minutes.

Fifth step: A reagent for each of the different types of assays is injected into each respective compartment. In this step, even when a high-concentration reagent is directly injected into each compartment, the injected extracellular electrical potential recording solution may be replaced with a previously prepared extracellular electrical potential recording solution in which the concentration has been adjusted according to the assay item.

Sixth step: After a pause as described in the 4th Step, the electrical potential changes of the measurement electrode 21 are measured for a predetermined period with reference to the inner wall of the compartment body 1, which serves as a reference electrode, thereby measuring and recording the stable neuroelectrical activity.

As described above, a pharmacological effect in each compartment can be determined by measuring the electrical potential of each measurement electrode before and after injecting a reagent into each compartment. The pharmacological effect of each reagent can be evaluated by comparing and examining the measurement results. The timing for pressing the compartment body into place and injecting the reagent, and the length of the pause should be suitably determined according to the measurement object and type of nerve cell.

Measurement and recording may continue at a suitable time interval after the 6th step. In order to examine the continuous effect of a reagent, it is effective to continuously repeat measurement and recording at a sufficient time interval after injecting the reagent by replacing the injected reagent with an extracellular electrical potential recording solution containing no reagent. These additional measurements can be carried out, if required, according to the targeted examination content.

When employing this compartment pressing method, the compartment body is pressed onto the substrate surface where cells are already cultivated, and thus there is almost no diffusion or mixing of solutions injected in compartments. Therefore, two or more different reagents can be evaluated at one time. Since a neuronal network is obtained in each compartment when a network cultivated as a single nerve cell is divided into parts immediately before measurement, each neuronal network can be assumed to be very similar. This allows evaluation free from any influence due to differences in the nerve cells. Also, since the compartments are in close proximity, variations depending on the culture environment can be suppressed.

The above description refers to a case where nerve cells are divided into parts by the compartment body. Alternatively, the compartment body can be loosely pressed onto a substrate while preventing the diffusion of the solution between compartments and avoiding the decoupling of nerve cells, thereby measuring the effect of different reagents on various parts of one neuronal network. For example, when using silicone grease for pressing the compartment body into place, the pressing-on is made possible by controlling the amount of silicone grease to adjust the space between the compartment body 1 and the electrode substrate 2 in a range of several tens of μm.

Hereinafter, the measurement method of a pharmacological effect using the compartment culture method is explained. When employing the compartment culture method, pharmacological effects can be measured using the following steps.

First step: The compartment body 1 is, in advance, adhered and fixed onto the electrode substrate 2 inside the cylindrical member 3, and in this condition, nerve cells are cultivated in each compartment. For example, after injecting the nerve cells into each compartment using a pipette tip that fits easily into each compartment, the nerve cells are allowed to stand until they settle on the bottom of the culture dish. A culture medium not containing nerve cells is poured into each compartment after an appropriate time. In this process, the level of the culture medium surface in each compartment is brought to the same height as, or higher than, that of the compartment body. The culture medium is then further added to the compartment until the liquid surface level is above the height of the compartment body, and culture is initiated in a CO₂ incubator. These processes prevent bubble from gathering in the compartments of the compartment body.

Pharmacological effects can be determined by conducting the following steps in the same manner as in the third to sixth steps described above for the compartment pressing method. The pharmacological effect of each reagent can be evaluated by comparing and examining the measurement results. The timing for injecting the reagent and the length of the pause should be determined as necessary.

Also, in the pharmacological effect measurement method employing the compartment culture method, measurement and recording may continue at a suitable time interval in the same manner as conducted after the above-described 6th step of the pharmacological effect measurement method employing the compartment pressing method. In order to examine the continuous effect of a reagent, it is effective to repeat measurement and recording continuously at a sufficient time interval after the application of a reagent while replacing the applied reagent with an extracellular electrical potential recording solution containing no reagent.

In the case of the compartment culture method, since the liquid surface level is raised at the time of culture, components contained in the culture medium can be spread over all independent compartments by diffusion, and the culture conditions of all compartments can be made the same.

Further, the same measurement can be performed using a compartment body with compartments having different areas as shown in FIG. 4 and employing the above-described compartment pressing method or compartment culture method. More specifically, the size of the neuronal network varies as the culture area varies. Thus, the difference in the effect of injecting different types of reagents on neuronal networks in which the electrical activity characteristics differ due to size variation can be compared and measured.

(Example)

Hereinafter, the characteristics of the invention are further clarified with reference to the following example.

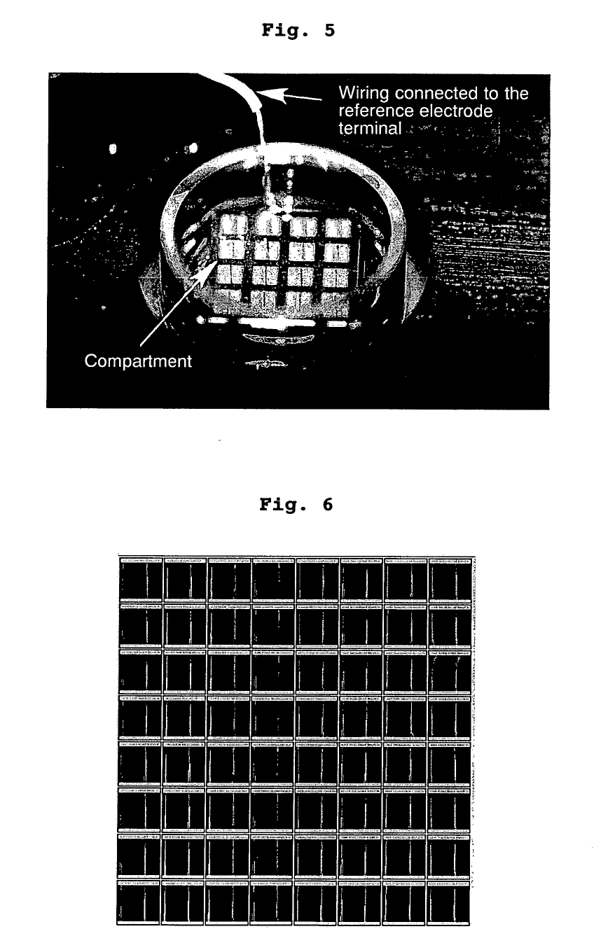

FIG. 5 shows a prototype of a compartment-arrayed extracellular electrical potential measurement probe for assaying the pharmacological effect on an organic neuronal network. The compartment-arrayed extracellular electrical potential measurement probe was connected to a commercially-available extracellular electrical potential recording system (MED-64 integrated system: manufactured by Alpha MED Sciences), and the electrical potential of the measurement electrode was observed, thus confirming the efficacy thereof.

First, four measurement electrodes and one reference electrode were disposed in a region inside each compartment on an electrode substrate, and an electrical potential measurement was performed. In this process, the measurement was performed under the state in which a culture medium was injected into the electrical potential measurement probe, but nerve cells were not cultivated. The result is shown in FIG. 6. In FIG. 6, the observed signal of each measurement electrode is bounded by a frame, and each frame corresponds to the arrangement on an electrode substrate. In each frame, the horizontal axis represents time and the vertical axis represents electrical potential. It can be observed from FIG. 6 that the oscillation resulting from a high level of impedance in the reference electrode occurred in the observation signals of all measurement electrodes (the black out part corresponds to a high-frequency signal exceeding the measurement level).

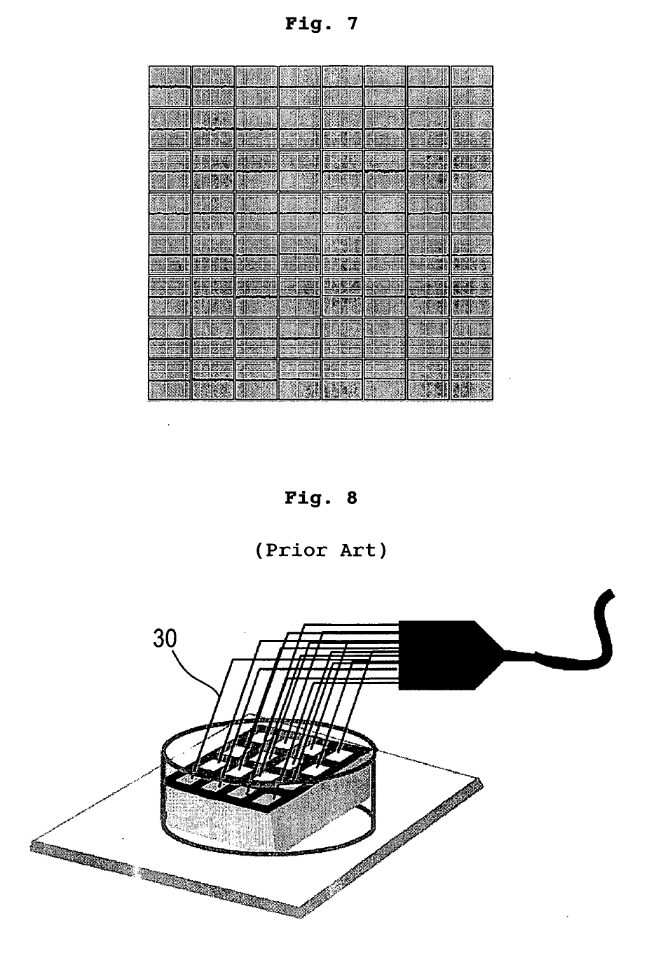

Next, the same measurement was performed using the compartment-arrayed extracellular electrical potential measurement probe shown in FIG. 5. The results are shown in FIG. 7 in the same way as in FIG. 6. As is clear from FIG. 7, no oscillation was observed and only slight noise was observed in the observation signals of all measurement electrodes. As described above, the use of the compartment-arrayed extracellular electrical potential measurement probe of the invention allows stable measurement of electrical potential.

1. A compartment-arrayed probe for measuring extracellular electrical potential which has a plurality of measurement electrodes, the probe comprising:
a compartment body having a plurality of through-holes; and
an electrode substrate composed of a non-electrically conductive material, on one surface of which the plurality of measurement electrodes are disposed and a tubular member is disposed in such a manner as to surround the measurement electrodes; wherein
one surface of the compartment body to which each of the through-holes opens is adhered to an area surrounded by the tubular member on the electrode substrate in such a manner that at least a part of the plurality of through-holes surround a part of the plurality of measurement electrodes;
an inner wall surface of the through-hole contacting a culture medium when it is injected thereinto, the inner wall surface being composed of an electrically conductive material; and
the electrical potential of the measurement electrode is measured with reference to the part of the inner wall surface of the through-hole contacting the culture medium as a reference electrode.

2. A compartment-arrayed probe for measuring extracellular electrical potential according to claim 1, wherein the entire compartment body is composed of an electrically conductive material.

3. A compartment-arrayed probe for measuring extracellular electrical potential according to claim 1, wherein
the compartment body is composed of a non-electrically conductive material; and
the compartment body has a surface which is plated, or to which an electrically conductive coating is applied or sprayed.

4. A compartment-arrayed probe for measuring extracellular electrical potential according to claim 1, wherein the inner surface of the through-hole is composed of silver-silver chloride.

5. A compartment-arrayed probe for measuring extracellular electrical potential according to claim 1, wherein the openings of the plurality of through-holes are equal in shape and area.

6. A compartment-arrayed probe for measuring extracellular electrical potential according to claim 2, wherein the openings of the plurality of through-holes are equal in shape and area.

7. A compartment-arrayed probe for measuring extracellular electrical potential according to claim 3, wherein the openings of the plurality of through-holes are equal in shape and area.

8. A compartment-arrayed probe for measuring extracellular electrical potential according to claim 4, wherein the openings of the plurality of through-holes are equal in shape and area.

9. A compartment-arrayed probe for measuring extracellular electrical potential according to claim 1, wherein
the openings of the plurality of through-holes are equal in shape; and
among the plurality of through-holes, the area of some through-holes varies in an approximate geometric progression relative to a predetermined through-hole opening area.

10. A compartment-arrayed probe for measuring extracellular electrical potential according to claim 2, wherein
the openings of the plurality of through-holes are equal in shape; and
among the plurality of through-holes, the area of some through-holes varies in an approximate geometric progression relative to a predetermined through-hole opening area.

11. A compartment-arrayed probe for measuring extracellular electrical potential according to claim 3, wherein
the openings of the plurality of through-holes are equal in shape; and
among the plurality of through-holes, the area of some through-holes varies in an approximate geometric progression relative to a predetermined through-hole opening area.

12. A compartment-arrayed probe for measuring extracellular electrical potential according to claim 4, wherein
the openings of the plurality of through-holes are equal in shape; and
among the plurality of through-holes, the area of some through-holes varies in an approximate geometric progression relative to a predetermined through-hole opening area.

13. A compartment-arrayed probe for measuring extracellular electrical potential according to claim 1, wherein
the tubular member is a cylindrical shape,
the plurality of measurement electrodes are disposed on the electrode substrate at predetermined intervals between each other, and
the compartment body is:
substantially inscribed in the tubular member;
in the form of a lattice in an approximately rectangular shape; and
adhered to one surface of the electrode substrate using an adhesive water-repellent material.

14. A compartment-arrayed probe for measuring extracellular electrical potential according to claim 2, wherein
the tubular member is a cylindrical shape,
the plurality of measurement electrodes are disposed on the electrode substrate at predetermined intervals between each other, and
the compartment body is:
substantially inscribed in the tubular member;
in the form of a lattice in an approximately rectangular shape; and
adhered to one surface of the electrode substrate using an adhesive water-repellent material.

15. A compartment-arrayed probe for measuring extracellular electrical potential according to claim 3, wherein
the tubular member is a cylindrical shape,
the plurality of measurement electrodes are disposed on the electrode substrate at predetermined intervals between each other, and
the compartment body is:
substantially inscribed in the tubular member;
in the form of a lattice in an approximately rectangular shape; and
adhered to one surface of the electrode substrate using an adhesive water-repellent material.

16. A compartment-arrayed probe for measuring extracellular electrical potential according to claim 4, wherein
the tubular member is a cylindrical shape,
the plurality of measurement electrodes are disposed on the electrode substrate at predetermined intervals between each other, and
the compartment body is:
substantially inscribed in the tubular member;
in the form of a lattice in an approximately rectangular shape; and
adhered to one surface of the electrode substrate using an adhesive water-repellent material.

17. A method for measuring a pharmacological effect using a compartment-arrayed probe for measuring extracellular electrical potential comprising:
a compartment body having a plurality of through-holes whose inner walls are at least partially composed of an electrically conductive material; and
an electrode substrate composed of a non-electrically conductive material, on one surface of which the plurality of measurement electrodes are disposed and a tubular member is disposed in such a manner as to surround the measurement electrodes, wherein
one surface of the compartment body to which the through-holes open is adhered to an area surrounded by the tubular member on the electrode substrate in such a manner that at least a part of the plurality of through-holes surround a part of the plurality of measurement electrodes, the method comprising:
a first step of injecting a culture medium inside the tubular member of the compartment-arrayed probe for measuring extracellular electrical potential in such a manner as to submerge the compartment body so as to culture a nerve cell;
a second step of replacing the culture medium in the through-hole with an extracellular electrical potential recording medium while injecting the recording medium in such a manner as to contact part of the inner wall surface;
a third step of measuring the electrical potential of the measurement electrode after a predetermined interval of time with reference to the part of the inner wall surface of the through-hole contacting the culture medium as a reference electrode;
a fourth step of injecting a reagent to be assayed into each of the through-holes; and
a fifth step of measuring the electrical potential of the measurement electrode after a predetermined interval of time with reference to the part of the inner wall surface of the through-hole contacting the culture medium as a reference electrode.

18. A method for measuring a pharmacological effect according to claim 17, wherein the openings of the plurality of through-holes are equal in shape and area.

19. A method for measuring a pharmacological effect according to claim 17, wherein
the openings of the plurality of through-holes are equal in shape; and
among the plurality of through-holes, the area of some through-holes varies in an approximate geometric progression relative to a predetermined through-hole opening area.

20. A method for measuring a pharmacological effect comprising:
a first step of culturing a nerve cell on a predetermined area surrounded by a tubular member on an electrode substrate composed of a non-electrically conductive material, on one surface of which a plurality of measurement electrodes are disposed and the tubular member is disposed in such a manner as to surround the measurement electrodes;
a second step of adhering one surface of a compartment body to which a plurality of through-holes open to the predetermined area in such a manner that at least a part of the plurality of through-holes surround a part of the plurality of measurement electrodes, wherein inner walls of the through-holes are at least partially composed of an electrically conductive material;
a third step of replacing the culture medium in each through-hole with an extracellular electrical potential recording medium while injecting the medium in such a manner as to contact part of the inner wall surface;
a fourth step of measuring the electrical potential of the measurement electrodes after a predetermined interval of time with reference to the part of the inner wall surface of the through-hole contacting the culture medium as a reference electrode;
a fifth step of injecting a reagent to be assayed into each of the through-holes; and
a sixth step of measuring the electrical potential of the measurement electrodes after a predetermined interval of time with reference to the part of the inner wall surface of the through-hole contacting the culture medium as a reference electrode.

21. A method for measuring a pharmacological effect according to claim 20, wherein the openings of the plurality of through-holes are equal in shape and area.

22. A method for measuring a pharmacological effect according to claim 20, wherein
the openings of the plurality of through-holes are equal in shape; and
among the plurality of through-holes, the area of each of some through-holes varies in an approximate geometric progression relative to a predetermined through-hole opening area.
